(19) United States
(12) Patent Application Publication
(10) Pub. No.: US 2016/0311145 A1
(43) Pub. Date: Oct. 27, 2016

(54) MOLDING MOLD, MOLDED ARTICLE, AND MOLDING METHOD OF MOLDED ARTICLE

(71) Applicant: Koito Manufacturing Co., Ltd., Tokyo (JP)

(72) Inventors: Takahito Osawa, Shizuoka-shi (Shizuoka) (JP); Masashi Katayama, Shizuoka-shi (Shizuoka) (JP); Kenji Yoshida, Shizuoka-shi (Shizuoka) (JP); Mamoru Kosuge, Shizuoka-shi (Shizuoka) (JP)

(21) Appl. No.: 15/098,374

(22) Filed: Apr. 14, 2016

(30) Foreign Application Priority Data
Apr. 23, 2015 (JP) 2015-088558

(51) Int. Cl. B29C 45/17; B29C 45/00

(52) U.S. Cl. CPC B29C 45/174; B29C 45/0001; B29C 45/0025; B29C 45/1701

(57) ABSTRACT

Provided is a molding mold including a fixed mold and a movable mold which are caused to abut on each other so as to form a cavity. An air supply path configured to supply air and a gas discharge path configured to discharge a gas are formed in the fixed mold or the movable mold, the air supply path and the gas discharge path are communicated with the cavity, and a molten resin is filled in the cavity in a state where the cavity is maintained at a pressure higher than an atmospheric pressure by the air supplied from the air supply path.

### CROSS-REFERENCE TO RELATED APPLICATIONS

This application is based on and claims priority from Japanese Patent Application No. 2015-088558, filed on Apr. 23, 2015, with the Japan Patent Office, the disclosure of which is incorporated herein in its entirety by reference.

### TECHNICAL FIELD

The disclosure relates to a technical field of a molding mold in which a fixed mold and a movable mold are caused to abut on each other to form a cavity, a molded article, and a molding method of the molded article.

### BACKGROUND

There is a molding mold in which a fixed mold and a movable mold are caused to abut on each other so as to form a cavity. In such a molding mold, a molten resin is filled in the cavity, and the filled molten resin is solidified to mold a molded article.

However, when the molded article is molded by the molding mold, for example, an internal mold release agent or a UV absorber contained in the molten resin may be turned into a gas and the gas may be generated from the molten resin filled in the cavity. Since the gas may contaminate the surface of the molded article or the molding surface of the molding mold, it is necessary to discharge the gas to the outside of the molding mold.

As a method of discharging a gas to the outside of a molding mold, a method disclosed in Japanese Patent Laid-Open Publication No. 2012-035469 is known. The method maintains the cavity of the molding mold at a constant pressure by supplying air to the cavity, and then, discharges the gas to the outside of the molding mold by evacuation during the filling of a molten resin.

### SUMMARY

When a gas is discharged to the outside of the molding mold by evacuation, the generation of the gas from the molten resin is facilitated according to the decrease of the pressure in the cavity so that a gas discharge may not be sufficiently performed. Then, the influence of the gas on the molded article or the molding mold may not be sufficiently suppressed so that the yield of the molded article may be reduced.

Meanwhile, when a resin material generating a small amount of gas, such as, for example, a high transmittance polycarbonate, is used, the problem described above may be solved. However, such a resin material is expensive, thereby causing a problem of increasing a production cost by the molding mold.

Therefore, an object of the molding mold, the molded article and the molding method of the molded article according to the present disclosure is to overcome the above-described problem, thereby achieving both the reduction of a cost and the improvement of quality of the molded article.

A molding mold according to the present disclosure includes a fixed mold and a movable mold which are caused to abut on each other so as to form a cavity. An air supply path configured to supply air and a gas discharge path configured to discharge a gas are formed in the fixed mold or the movable mold, the air supply path and the gas discharge path are communicated with the cavity, and a molten resin is filled in the cavity in a state where the cavity is maintained at a pressure higher than an atmospheric pressure by the air supplied from the air supply path.

This suppresses a gas from being generated from the molten resin, and the generated gas is discharged from the gas discharge path together with air.

In the molding mold according to the present disclosure, the molten resin filled in the cavity is transparent so as to mold a transparent member of a vehicle lamp. The transparent member includes a transmission portion through which light emitted from a light source disposed within the vehicle lamp is transmitted, and the air supply path and the gas discharge path may be communicated with a portion of the cavity other than a portion that molds the transmission portion.

Accordingly, the air flowing from the air supply path is hardly blown to the molten resin filled in a portion of the cavity for molding the transmission portion.

In the molding mold according to the present disclosure, at least one of the air supply path and the gas discharge path may be formed at a position including a parting line between the fixed mold and the movable mold.

Accordingly, the fixed mold and the movable mold are caused to abut on the each other to form at least one of the air supply path and the gas discharge path.

In the molding mold according to the present disclosure, an air outlet of the air supply path to the cavity is formed as an air inflow port, an gas inlet of the gas discharge path from the cavity is formed as a gas outflow port, and the air inflow port may be located nearer to a gate than the gas outflow port.

Accordingly, an air flow path is likely to be formed in the cavity.

In the molding mold according to the present disclosure, the cavity may be maintained at a pressure in a range of 0.2 MPa to 1.5 MPa due to the air supplied from the air supply path.

Accordingly, the cavity is maintained at a pressure sufficiently higher than the atmospheric pressure.

The molding method of a molded article according to the present disclosure is a method of molding a molded article by a molding mold in which an air supply path configured to supply air and a gas discharge path configured to discharge a gas are formed in a fixed mold or a movable mold. The method includes: causing the fixed mold and the movable mold to abut on each other to form a cavity; supplying the air to the cavity from the air supply path so that the cavity is maintained at a pressure higher than an atmospheric pressure; and filling a molten resin in the cavity maintained at the pressure higher than the atmospheric pressure.

This suppresses a gas from being generated from the molten resin, and the generated gas is discharged from the gas discharge path together with air.

The molded article according to the present disclosure is an article molded by a molding mold in which an air supply path configured to supply air and a gas discharge path configured to discharge a gas are formed in a fixed mold or a movable mold. The molded article is molded by filling a molten resin in a cavity formed by causing the fixed mold and the movable mold to abut on each other while the cavity is maintained at a pressure higher than an atmospheric pressure due to the air supplied from the air supply path.

This suppresses generation of a gas, and while the generated gas is discharged from the gas discharge path together with air, the molded article is molded by the molten resin.

According to the present disclosure, a gas is suppressed from being generated from a molten resin and the generated gas is discharged from the gas discharge path together with air. Thus, a cost reduction and a quality improvement of the molded article may be achieved.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a schematic sectional view illustrating a molding mold according to an exemplary embodiment of the present disclosure, together with FIGS. 2 to 5.

FIG. 2 is a schematic sectional view illustrating a lamp cover of a vehicle lamp, which is molded as a molded article.

FIG. 3 is a schematic sectional view illustrating a state in which a molten resin is filled in a cavity, together with an air flow path.

FIG. 4 is a schematic sectional view illustrating a state in which a molten resin is filled in the molding mold.

FIG. 5 is a schematic plan view illustrating a modification of a molding mold.

### DETAILED DESCRIPTION

In the following detailed description, reference is made to the accompanying drawing, which form a part hereof. The illustrative embodiments described in the detailed description, drawing, and claims are not meant to be limiting. Other embodiments may be utilized, and other changes may be made, without departing from the spirit or scope of the subject matter presented here.

Hereinafter, an exemplary embodiment of the present disclosure will be described with reference to accompanying drawings.

<Structure of Molding Mold and Shape of Molded Article>

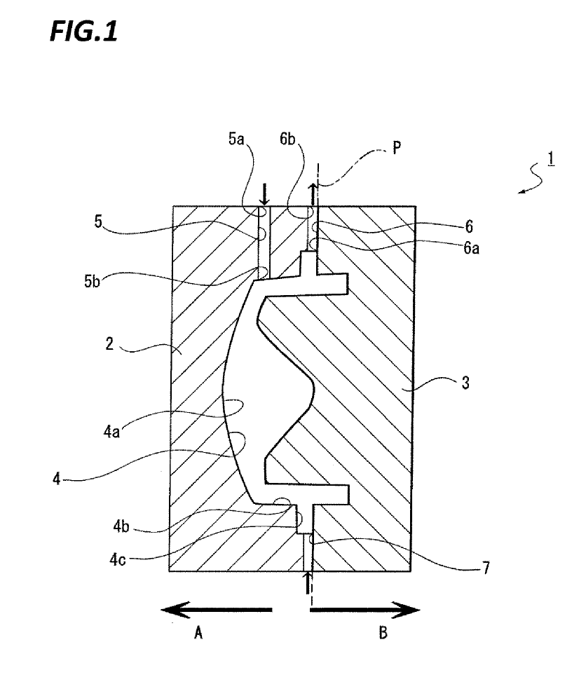

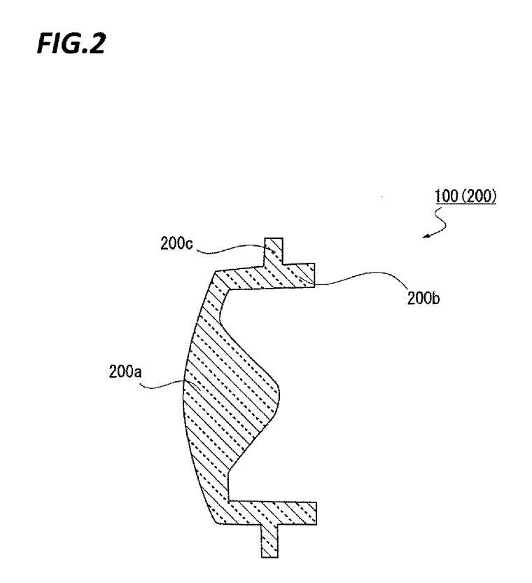

First, descriptions will be made on a structure of a molding mold 1 and a shape of a molded article 100 molded by the molding mold 1 (see, e.g., FIGS. 1 and 2).

The molding mold 1 includes a fixed mold 2 and a movable mold 3 (see, e.g., FIG. 1).

In the molding mold 1, the fixed mold 2 and the movable mold 3 are caused to abut on each other so as to form a cavity 4 to be filled with a molten resin. In the following description of the molding mold 1, a separating/abutting direction when closing/opening the fixed mold 2 and the movable mold 3 is defined as a forward direction/rearward direction (“A” direction/“B” direction illustrated in FIG. 1).

When the molten resin is filled in the cavity 4 and cooled, the molded article 100 is molded (see, FIG. 2). As the molten resin, for example, a transparent resin material such as, for example, acrylonitrile butadiene styrene (ABS) is used, and as the molded article 100, for example, a lamp cover 200 serving as a transparent member of a vehicle lamp is molded. The molten resin is not limited to the transparent ABS, but may be a non-transparent resin material, or other resin materials such as, for example, polymethyl methacrylate (PMMA) or polycarbonate (PC). The molded article 100 is not limited to the lamp cover 200, but may be another molded article as long as it can be molded by injection molding. In particular, the molded article 100 may be a molded article that constitutes a vehicle lamp such as, for example, an inner lens, a light guide lens, a lamp housing, or an extension.

The lamp cover 200 includes a transmission portion 200a, an outer frame portion 200b, and a flange portion 200c.

The transmission portion 200a is a portion through which light emitted from a light source (not illustrated) disposed within the vehicle lamp is transmitted. The outer frame portion 200b is a portion protruding rearward from the outer periphery of the transmission portion 200a. The flange portion 200c is a portion protruding outward from the outer periphery surface of the outer frame portion 200b.

The cavity 4 includes a lens molding portion 4a, an outer frame molding portion 4b, and a flange molding portion 4c (see, e.g., FIG. 1).

The lens molding portion 4a is a portion by which the transmission portion 200a of the lamp cover 200 is molded. The outer frame molding portion 4b is a portion by which the outer frame portion 200b of the lamp cover 200 is molded. The flange molding portion 4c is a portion by which the flange portion 200c of the lamp cover 200 is molded.

An air supply path 5 and a gas discharge path 6 are formed in the molding mold 1.

The air supply path 5 is formed on, for example, the fixed mold 2. The position where the air supply path 5 is formed is not limited to the fixed mold 2, but may be the movable mold 3 or a position straddling the fixed mold 2 and the movable mold 3.

The air supply path 5 has a function of supplying air to the cavity 4, and includes an inlet formed as an air supply port 5a and an outlet formed as an air inflow port 5b. The air supply port 5a is communicated with the outside of the molding mold 1, and the air inflow port 5b is communicated with the outer frame molding portion 4b of the cavity 4. Meanwhile, the air inflow port 5b may be communicated with the lens molding portion 4a or the flange molding portion 4c of the cavity 4.

The gas discharge path 6 is formed on, for example, a position including a parting line P between the fixed mold 2 and the movable mold 3. The position where the gas discharge path 6 is formed is not limited to the position including the parting line P between the fixed mold 2 and the movable mold 3, but may be the fixed mold 2 or the movable mold 3.

The gas discharge path 6 has a function of discharging the air supplied to the cavity 4 through the air supply path 5 and the gas that may be generated from a molten resin to the outside of the molding mold 1, and includes an inlet formed as a gas outflow port 6a, and an outlet formed as a gas discharge port 6b. The gas outflow port 6a is communicated with the flange molding portion 4c, and the gas discharge port 6b is communicated with the outside of the molding mold 1. Meanwhile, the gas outflow port 6a may be communicated with the lens molding portion 4a or the outer frame molding portion 4b of the cavity 4.

A gate 7 is communicated with a portion at the 180° opposite side to a portion of the flange molding portion 4c which is communicated with the gas outflow port 6a. The air inflow port 5b of the air supply path 5 is located nearer to the gate 7 than the gas outflow port 6a of the gas discharge path 6.

As described above, the gas discharge path 6 is formed at a position including the parting line P between the fixed mold 2 and the movable mold 3.

Accordingly, since the gas discharge path 6 is formed by causing the fixed mold 2 and the movable mold 3 to abut on each other, the number of steps of forming the gas discharge path 6 is reduced, thereby achieving the reduction of a production cost of the molding mold 1. In particular, the gas discharge path 6 may be formed without performing a drilling process on the fixed mold 2 or the movable mold 3, thereby achieving the reduction of a manufacturing time and production cost of the molding mold 1.

On the contrary, the air supply path 5 may be formed at a position including the parting line P between the fixed mold 2 and the movable mold 3.

Accordingly, since the air supply path 5 is formed by causing the fixed mold 2 and the movable mold 3 to abut on each other, the number of steps of forming the air supply path 5 is reduced, thereby achieving the reduction of a production cost and manufacturing time of the molding mold 1.

Since the air supply path 5 and the gas discharge path 6 are communicated with a portion of the cavity 4 other than the lens molding portion 4a, air flowing from the air supply path 5 is hardly blown to the molten resin filled in the lens molding portion 4a for molding the transmission portion 200a.

Therefore, recesses or protrusions are hardly formed on the molded transmission portion 200a by blowing of the air, and thus an excellent moldability of the transmission portion 200a is secured so that a proper light distribution pattern may be formed by light emitted from the light source.

<Molding Procedure in Molding Mold>

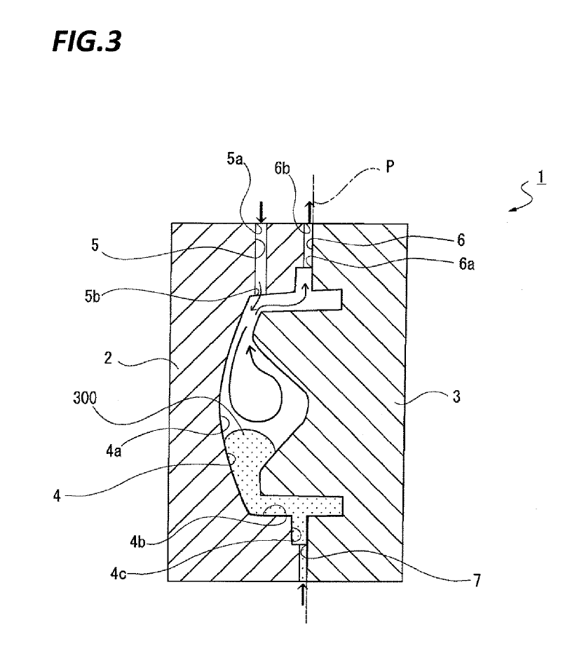

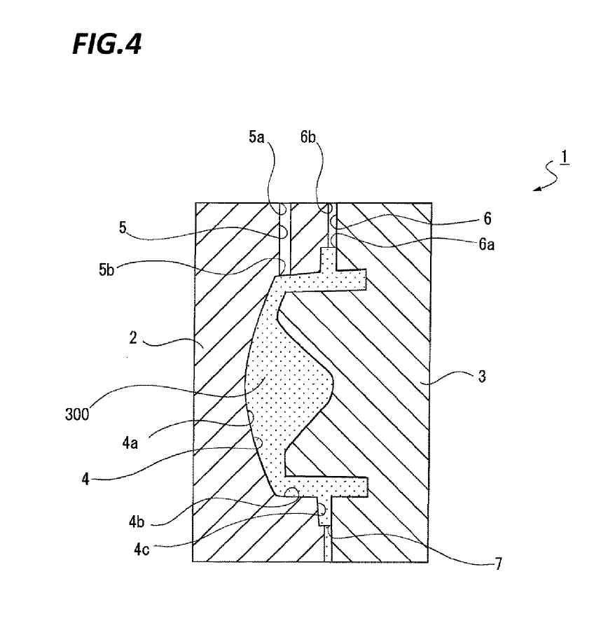

Hereinafter, descriptions will be made on the procedure of molding the molded article 100 in the molding mold 1 (see, e.g., FIGS. 3 and 4).

First, in the molding mold 1, the fixed mold 2 and the movable mold 3 are caused to abut on each other so as to form the cavity 4 (see, e.g., FIG. 3).

Then, air flows into the cavity 4 from the air supply path 5. The air flowing into the cavity 4 is a high-pressure air, and the cavity 4 is maintained at a pressure higher than the atmospheric pressure, for example, in a range of 0.2 MPa to 1.5 MPa by the air flowed into the cavity 4. Also, the cavity 4 may be maintained at a pressure higher than the atmospheric pressure, and may be less than 0.2 MPa and higher than 1.5 MPa.

Here, an air flow path is formed within the molding mold 1 by the air flowed into the cavity 4.

The air flow path as illustrated in FIG. 3 refers to a flow path in which the air flows into the lens molding portion 4a from the air supply path 5 through the outer frame molding portion 4b to be circulated in the lens molding portion 4a, and sequentially flows through the outer frame molding portion 4b, and the flange molding portion 4c to be discharged to the outside of the molding mold 1 through the gas discharge path 6.

When the cavity 4 is maintained at a pressure in a range of 0.2 MPa to 1.5 MPa, a molten resin 300 is injected into the cavity 4 from the gate 7 through a runner (not illustrated) to be gradually filled in the cavity 4.

During the filling of the molten resin 300 in the cavity 4, for example, an internal mold release agent or a UV absorber may be turned into a gas and the gas may be generated from the molten resin 300.

Since the air flow path is formed within the molding mold 1, the generated gas, together with the air, flows from the lens molding portion 4a through the outer frame molding portion 4b and the flange molding portion 4c and is discharged to the outside of the molding mold 1 from the gas discharge path 6.

Accordingly, the adhesion of the gas on the molding surface of the molding mold 1 may be reduced, and thus the maintenance cost of the molding mold 1 may be reduced. Also, the contamination of the molded article 100 may be reduced so that the quality of the molded article 100 may be improved.

Since the molten resin 300 is filled in the cavity 4 while the cavity 4 is maintained at a pressure higher than the atmospheric pressure, a gas is suppressed from being generated from the molten resin 300 due to the pressure of the air.

Accordingly, even in an inexpensive resin material which tends to generate a larger amount of gas than an expensive resin material, the generation amount of gas is decreased. Thus, the inexpensive resin material may be used as the molten resin 300. Therefore, the production cost of the molded article 100 may be reduced and the quality may be improved.

The cavity 4 is maintained at a pressure in a range of 0.2 MPa to 1.5 MPa, which is sufficiently higher than the atmospheric pressure.

Accordingly, during the filling of the molten resin 300 in the cavity 4, the gas may be effectively suppressed from being generated from the molten resin 300.

The air inflow port 5b of the air supply path 5 is located nearer to the gate 7 than the gas outflow port 6a of the gas discharge path 6.

Accordingly, the above-described air flow path is likely to be formed, and thus the gas generated from the molten resin 300 may be reliably and effectively discharged to the outside of the molding mold 1.

Subsequently, when the molten resin 300 is filled in the whole of the cavity 4, the injection of the molten resin 300 from the gate 7 to the cavity 4 is stopped (see, e.g., FIG. 4).

When the injection of the molten resin 300 to the cavity 4 is stopped, the molten resin 300 filled in the cavity 4 is cooled and solidified.

When the molten resin 300 filled in the cavity 4 is cooled and solidified, the movable mold 3 is moved rearward (in the B direction illustrated in FIG. 1), and separated from the fixed mold 2. Then, the solidified molten resin 300 is pushed out as a molded article 100 by an ejector pin (not illustrated) to be taken out from the cavity 4. In the present exemplary embodiment, the air inflow port 5b is located nearer to the gate 7 than the gas outflow port 6a. However, the air supply path 5 and the gas discharge path 6 may be positioned in reverse such that the gas outflow port 6a may be located nearer to the gate 7 than the air inflow port 5b. In this case, by the air flowing from the air supply port 5a, the gas generated from the molten resin 300 may be suppressed from being adhered on the inner surface of the outer frame molding portion 4b and the flange molding portion 4c at the gas discharge path 6 side.

<Modification of Molding Mold>

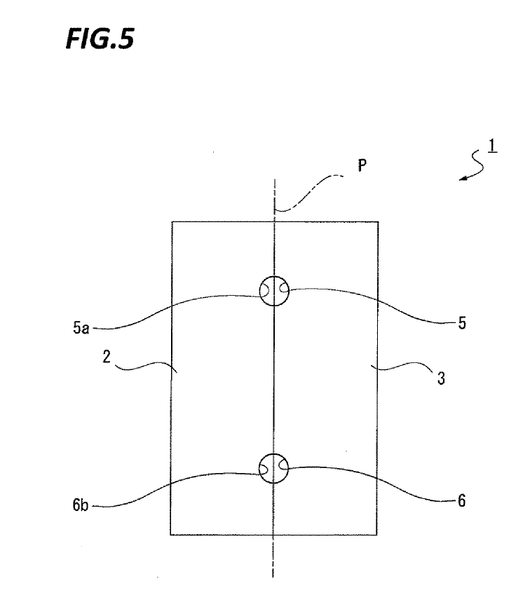

Hereinafter, a modification of the molding mold 1 will be described (see, e.g., FIG. 5).

In the example described above, any one of the air supply path 5 and the gas discharge path 6 is formed at a position including the parting line P, but both of the air supply path 5 and the gas discharge path 6 may be formed at a position including the parting line P.

As described above, when both of the air supply path 5 and the gas discharge path 6 are formed at a position including the parting line P, the fixed mold 2 and the movable mold 3 are caused to abut on each other so that both of the air supply path 5 and the gas discharge path 6 are formed. Thus, the number of steps of forming both the air supply path 5 and the gas discharge path 6 is reduced, thereby achieving the additional reduction of a production cost of the molding mold 1.

<Others>

In the example described above, the molding mold 1 is configured by the fixed mold 2 and the movable mold 3, but an insert (not illustrated) such as, for example, a slider may be provided in the molding mold 1, in addition to the fixed mold 2 and the movable mold 3.

In this case, the whole or a part of at least one of the air supply path 5 and the gas discharge path 6 may be formed on a part of the insert.

Accordingly, the number of steps of forming the air supply path 5 or the gas discharge path 6 is reduced, thereby achieving the reduction of a production cost of the molding mold 1.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. A molding mold comprising:
a fixed mold and a movable mold which are caused to abut on each other so as to form a cavity,
wherein an air supply path configured to supply air and a gas discharge path configured to discharge a gas are formed in the fixed mold or the movable mold,
the air supply path and the gas discharge path are communicated with the cavity, and
a molten resin is filled in the cavity in a state where the cavity is maintained at a pressure higher than an atmospheric pressure by the air supplied from the air supply path.

2. The molding mold of claim 1, wherein the molten resin filled in the cavity is transparent so as to mold a transparent member of a vehicle lamp,
the transparent member includes a transmission portion through which light emitted from a light source disposed within the vehicle lamp is transmitted, and
the air supply path and the gas discharge path are communicated with a portion of the cavity other than a portion that molds the transmission portion.

3. The molding mold of claim 1, wherein at least one of the air supply path and the gas discharge path is formed at a position including a parting line between the fixed mold and the movable mold.

4. The molding mold of claim 2, wherein at least one of the air supply path and the gas discharge path is formed at a position including a parting line between the fixed mold and the movable mold.

5. The molding mold of claim 1, wherein an air outlet of the air supply path to the cavity is formed as an air inflow port,
a gas inlet of the gas discharge path from the cavity is formed as a gas outflow port, and
the air inflow port is located nearer to a gate than the gas outflow port.

6. The molding mold of claim 2, wherein an air outlet of the air supply path to the cavity is formed as an air inflow port,
an gas inlet of the gas discharge path from the cavity is formed as a gas outflow port, and
the air inflow port is located nearer to a gate than the gas outflow port.

7. The molding mold of claim 3, wherein an air outlet of the air supply path to the cavity is formed as an air inflow port,
a gas inlet of the gas discharge path from the cavity is formed as a gas outflow port, and
the air inflow port is located nearer to a gate than the gas outflow port.

8. The molding mold of claim 4, wherein an air outlet of the air supply path to the cavity is formed as an air inflow port,
a gas inlet of the gas discharge path from the cavity is formed as a gas outflow port, and
the air inflow port is located nearer to a gate than the gas outflow port.

9. The molding mold of claim 1, wherein the cavity is maintained at a pressure in a range of 0.2 MPa to 1.5 MPa due to the air supplied from the air supply path.

10. The molding mold of claim 2, wherein the cavity is maintained at a pressure in a range of 0.2 MPa to 1.5 MPa due to the air supplied from the air supply path.

11. The molding mold of claim 3, wherein the cavity is maintained at a pressure in a range of 0.2 MPa to 1.5 MPa due to the air supplied from the air supply path.

12. The molding mold of claim 4, wherein the cavity is maintained at a pressure in a range of 0.2 MPa to 1.5 MPa due to the air supplied from the air supply path.

13. The molding mold of claim 5, wherein the cavity is maintained at a pressure in a range of 0.2 MPa to 1.5 MPa due to the air supplied from the air supply path.

14. A method of molding a molded article by a molding mold in which an air supply path configured to supply air and a gas discharge path configured to discharge a gas are formed in a fixed mold or a movable mold, the method comprising:
causing the fixed mold and the movable mold to abut on each other to form a cavity;
supplying the air to the cavity from the air supply path so that the cavity is maintained at a pressure higher than an atmospheric pressure; and
filling a molten resin in the cavity maintained at the pressure higher than the atmospheric pressure.

15. A molded article molded by a molding mold in which an air supply path configured to supply air and a gas discharge path configured to discharge a gas are formed in a fixed mold or a movable mold,
wherein the molded article is molded by filling a molten resin in a cavity formed by causing the fixed mold and the movable mold to abut on each other while the cavity is maintained at a pressure higher than an atmospheric pressure due to the air supplied from the air supply path.
